(19) United States
(12) Patent Application Publication
(10) Pub. No.: US 2003/0178579 A1
(43) Pub. Date: Sep. 25, 2003

(54) Stage devices exhibiting reduced deformation, and microlithography systems comprising same

(75) Inventors: Keiichi Tanaka, Ageo-City (JP); Yasushi Yoda, Fukaya shi (JP); Yukiharu Okubo, Kunagaya-shi (JP); Hiroaki Narushima, Tokyo-To (JP)

Correspondence Address: KLARQUIST SPARKMAN, LLP, One World Trade Center, Suite 1600, 121 S.W. Salmon Street, Portland, OR, 97204-2988, US

(73) Assignee: Nikon Corporation

(21) Appl. No.: 10/355,446

(22) Filed: Jan. 31, 2003

(30) Foreign Application Priority Data
Feb. 1, 2002 (JP) 2002-025231

(51) Int. Cl. G01J 1/00

(52) U.S. Cl. 250/491.1

(57) ABSTRACT

Stage apparatus are disclosed that exhibit reduced deformation that otherwise arises during assembly, as well as reduced deformation that otherwise accompanies vacuum evacuation of a vacuum chamber in which the stage apparatus is mounted. The stage apparatus include spherical static-pressure bearings situated between a stage base and the wall of the vacuum chamber to which the stage apparatus is mounted. Torque or other deformation-inducing stress otherwise exerted on the stage base and/or vacuum chamber is ameliorated by respective rotations of the spherical static-pressure bearings. By ameliorating such stress, stage deformation otherwise arising during assembly and chamber deformation otherwise arising during vacuum evacuation are reduced.

### FIELD

This disclosure pertains to microlithography (transfer-exposure, using an energy beam, of a pattern to a substrate that has been “sensitized” to exposure by the energy beam). Microlithography is a key technique used in the fabrication of microelectronic devices such as semiconductor integrated circuits, displays, and the like. More specifically, the disclosure pertains to stage apparatus upon which the substrate or a pattern-defining “reticle” is mounted for positioning and movements as required for making the exposure, and to microlithography systems comprising such stage apparatus. The subject stage apparatus are configured and assembled for exhibiting reduced deformations accompanying deformations normally occurring in walls of chambers, to which the stage apparatus are mounted, during assembly as well as during evacuation of such chambers containing the stage apparatus.

### BACKGROUND

A conventional microlithography system used in the fabrication of microelectronic devices typically includes respective stage apparatus for effecting high-speed movement and positioning of substrates (wafers) and of reticles. In conventional optical microlithography systems, each stage apparatus usually includes a precisely machined stone or ceramic stage base. Mounted to the stage base is a dual-axis guide bar that intersects a single-axis guide bar, and a stage table is mounted on the guide bars so as to move, while controlled and supported by the guide bars without actually contacting the guide bars, relative to the stage base. High rigidity of the stage table relative to the surface of the stage base is maintained by the guide bars and by vacuum suction of the stage table to the surface of the stage base. Due to its great thickness and rigidity, the stage base usually is mounted so as to be supported directly by a main frame of the microlithography system.

In a microlithography system utilizing a charged particle beam (e.g., electron beam) or extreme-UV (EUV) beam as a lithographic energy beam, exposure must be performed inside a vacuum chamber evacuated to a high vacuum. Thus, the respective stages for the reticle and substrate must be located and operable in a high-vacuum environment, where the stage tables cannot be pre-loaded by vacuum suction to respective rigid stage bases. Instead, a stage base is used that, for example, supports both ends of each of multiple single-axis guide bars. Each guide bar has associated therewith at least one respective slider constrained by four-face gas bearing(s) relative to the respective guide bars. With such a stage configuration, the stage base can be made as thin and lightweight as its means of support will allow. However, whenever these stage apparatus are assembled and disposed inside a vacuum chamber of the microlithography system, there is a risk that the stage base will exhibit deformation caused by stresses imparted during assembly and installation of the stage apparatus in the vacuum chamber and/or by evacuating the vacuum chamber containing the installed stage apparatus. Deformation of the stage base can result in overall deformation of the respective stage, which degrades exposure-scanning performance of the microlithography system and can cause damage to the stage apparatus itself. Also, since microlithography systems must perform at or near theoretical resolution limits, it is crucial that any such stage deformations that could adversely impact process results be rigorously eliminated.

### SUMMARY

In view of the shortcomings of conventional stage apparatus as summarized above, the present invention provides, inter alia, stage apparatus exhibiting reduced deformation arising during assembly and/or during evacuation of a chamber in which the stage apparatus has been installed. Also provided are microlithography systems comprising such stage apparatus.

According to a first aspect of the invention, stage apparatus are provided for moving an object relative to a mounting member. An embodiment of such a stage apparatus comprises a stage base, a stage table, an actuator, a guide mechanism, and multiple spherical static-pressure bearings. The actuator is coupled between the stage base and stage table, and is configured for moving and positioning the stage table relative to the stage base. The guide mechanism is mounted to the stage base and is configured to guide movements of the stage table imparted by the actuator. The multiple spherical static-pressure bearings are situated between the stage base and the mounting member.

The stage base typically is a plate having multiple corners, in which event a respective spherical static-pressure bearing is situated between each corner and the mounting member.

The stage can be, by way of example, a reticle stage or substrate stage for use in a microlithography system. With such stages, the object is a reticle or substrate, respectively.

Each spherical static-pressure bearing desirably comprises a respective bearing-locking mechanism. By way of example, each spherical static-pressure bearing comprises a bearing seat and a bearing body coupled together so as to define a spherical fluid bearing therebetween. In this configuration the bearing-locking mechanism further can comprise a lock screw extending between the bearing seat and the bearing body. The lock screw desirably is spring-loaded in an axial direction of the lock screw.

As noted above, each spherical static-pressure bearing can comprise a respective bearing seat and bearing body coupled together so as to define a respective spherical fluid bearing therebetween. In this configuration the fluid bearing desirably comprises a respective bearing pad through which a gas is discharged into the fluid bearing. Each fluid bearing also desirably comprises a concave bearing surface defined in the bearing seat, a mating convex bearing surface defined in the bearing body, and at least one exhaust groove defined in at least one of the bearing surfaces. The exhaust groove is configured to scavenge gas discharged from the respective bearing pad.

The stage apparatus further can comprise at least one height-adjustment mechanism situated either between the stage base and a respective spherical static-pressure bearing or between the respective spherical static-pressure bearing and the mounting member. Especially if the stage apparatus is configured for use inside a sealable chamber, the height-adjustment mechanism desirably is operable from outside the chamber.

The stage apparatus further can comprise at least one planar static-pressure bearing situated either between the spherical static-pressure bearings and the mounting member, between the spherical static-pressure bearings and the stage base, or between the stage base and the stage table.

According to another aspect of the invention, microlithography systems are provided for transferring a pattern to a sensitized substrate using an energy beam. An embodiment of such a system comprises an optical system situated and configured to direct the energy beam to the substrate, a mounting member, and a stage apparatus for moving the substrate or a reticle relative to the optical system. The stage apparatus can have any of various configurations as summarized above. The energy beam can be, for example, a charged particle beam or EUV beam, which requires a vacuum chamber. Hence, the system further can comprise a vacuum chamber housing at least the stage apparatus.

According to yet another aspect of the invention, methods are provided for mounting a stage apparatus to a mounting member. The stage apparatus can be a reticle stage or substrate stage used in a microlithography system. An embodiment of the method comprises multiple steps, as follows. In one step, multiple spherical static-pressure bearings are placed at respective locations between the stage base and a rigid base. While discharging a gaseous bearing fluid into the spherical static-pressure bearings, the bearings are allowed to rotate in response to deformation being exhibited by the stage base. In another step the stage apparatus is assembled, including assembling a stage table onto the stage base. Again while discharging the bearing fluid into the spherical static-pressure bearings, the bearings are allowed to rotate in response to deformation being exhibited by the stage resulting from assembling the stage. In another step, while suspending the stage from a hanger plate, the stage is transported to the mounting member and mounted by the spherical static-pressure bearings to the mounting member. Again while discharging the bearing fluid into the spherical static-pressure bearings, the bearings are allowed to rotate in response to deformation of the mounting member. Shims are installed as required between individual spherical bearings and the mounting member or between individual bearings and the stage base as required to offset deformation of the mounting member. Afterward, the spherical bearings are locked.

The mounting member can be, for example, a wall of a vacuum chamber in which the stage apparatus is mounted. In such an instance the method further can comprise the steps, before locking the spherical bearings, of evacuating the chamber and, while discharging the bearing fluid into the spherical static-pressure bearings, allowing the bearings to rotate in response to deformation of the wall arising in response to the evacuation of the chamber.

The step of locking the spherical bearings can comprise tightening a respective lock screw associated with each spherical bearing.

The method further can comprise the step of providing at least one planar static-pressure bearing situated either between the spherical static-pressure bearings and the mounting member, between the spherical static-pressure bearings and the stage base, or between the stage base and the stage table.

The foregoing and additional features and advantages of the invention will be more readily apparent from the following detailed description, which proceeds with reference to the accompanying drawings.

### BRIEF DESCRIPTION OF THE DRAWINGS

FIG. 1 is a schematic elevational view of the results of a first step in a representative embodiment of a process for assembling a stage apparatus of a microlithography system.

FIG. 2 is a schematic elevational view of the results of a second step in the assembly process.

FIG. 3 is a schematic elevational view of the results of a third step in the assembly process.

FIG. 4 is a schematic elevational view of the results of a fourth step (mounting of the stage apparatus to a wall of a chamber enclosing the stage apparatus) in the assembly process.

FIG. 5 is a schematic elevational view of the results of a fifth step (vacuum-evacuation step) in the assembly process.

FIG. 6 is an elevational section of an embodiment of a spherical static-pressure bearing for use in mounting a stage apparatus configured for use as a substrate stage.

FIG. 7 is an elevational section of an embodiment of a spherical static-pressure bearing for use in mounting a stage apparatus configured for use as a reticle stage.

FIG. 8 is a block diagram of various assemblies in a representative embodiment of a microlithography system comprising at least one stage apparatus assembled using a method as newly disclosed herein.

FIG. 9 is a schematic elevational diagram depicting certain optical relationships of an electron-beam microlithography system, such as the system shown in FIG. 8, for use in exposing a pattern defined on a divided reticle.

### DETAILED DESCRIPTION

The invention is described below in the context of representative embodiments that are not intended to be limiting in any way.

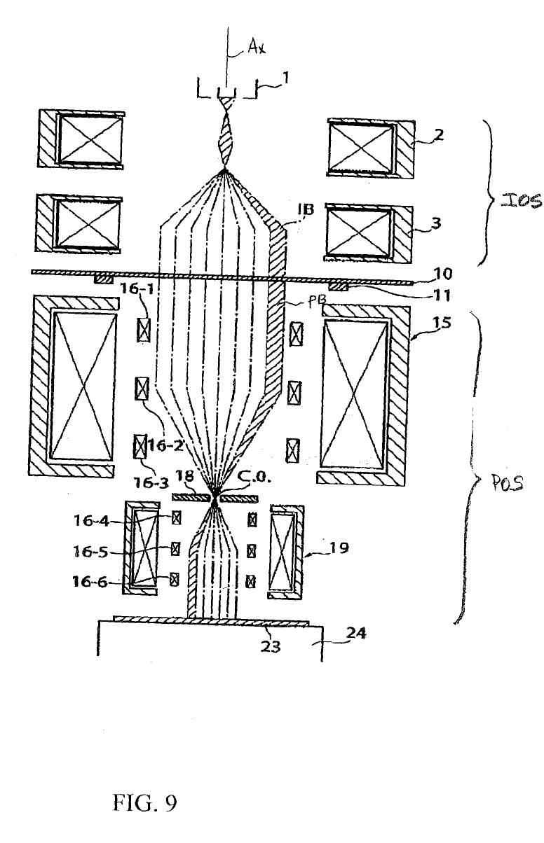

Overall structural and imaging relationships of an electron-beam microlithography system (as a representative microlithography system in which actual microlithographic exposures are performed under high vacuum) are shown in FIG. 9. An electron gun 1 is situated at the extreme upstream end of the depicted “electron-optical” system. The electron gun 1 emits an electron beam that propagates in the downstream direction (downward in the figure). Downstream of the electron gun 1 are a condenser lens 2 and an illumination lens 3 through which the electron beam passes to illuminate a reticle 10. The electron beam between the electron gun 1 and the reticle 10 is termed an “illumination” beam IB, and the optical components located between the electron gun 1 and the reticle 10 constitute an “illumination-optical system” IOS. In addition to the lenses 2, 3, the illumination-optical system IOS comprises several components that are not shown (but well-understood in the art), including a beam-shaping aperture, a blanking deflector, a blanking aperture, and an illumination-beam deflector. The illumination beam IB, shaped and directed by the illumination-optical system IOS, sequentially scans over the multiple exposure regions of the reticle 10 so as to “illuminate” the various exposure regions on the reticle 10 within the optical field of the illumination-optical system IOS.

As noted above, the reticle 10 is divided into multiple exposure regions usually termed “subfields.” The reticle 10 is divided in this manner because, in charged-particle-beam (CPB) and EUV microlithography, it currently is impossible to fabricate optical systems that can expose an entire die pattern with sufficiently low aberrations in a single exposure “shot.” (It also currently is impossible to fabricate a reticle defining a typically sized die pattern that can be exposed in one shot.) Thus, the reticle 10 is divided into a large number of subfields, each defining a respective portion of the pattern, that are individually exposed in a sequential manner. The respective images of the subfields formed on a downstream substrate 23 (e.g., semiconductor wafer) are positioned on the substrate in a contiguous manner so as collectively to form the entire die pattern on the substrate, despite the subfields having been individually exposed. To facilitate this divided-reticle exposure the reticle 10 is mounted on a movable reticle stage 11. During exposure of the subfields, the reticle stage 11 is moved as required within a plane perpendicular to the optical axis Ax so as to allow illumination of various subfields on the reticle that extend outside the optical field of the illumination-optical system IOs.

Downstream of the reticle 10 is a “projection-optical system” POS comprising a first projection lens 15, a second projection lens 19, and deflectors 161 through 16-6 used for correcting aberrations and for adjusting image positions on the substrate. The illumination beam IB passing through an illuminated subfield on the reticle 10 carries, downstream of the reticle 10, an aerial image of the respective pattern portion defined by the illuminated subfield. Thus, the beam downstream of the reticle 10 is termed a “patterned beam” PB or “imaging beam.” The patterned beam PB, directed and shaped by the projection-optical system POS, forms the respective image at a specified location on the substrate 23. So as to be imprintable with the image, the substrate 23 is coated with an exposure-sensitive material called a “resist” that reacts to exposure by the patterned beam PB in an image-imprinting way. Usually the image formed on the substrate 23 is “reduced” or “demagnified” relative to the corresponding pattern on the reticle 10. The amount of reduction or demagnification is expressed as a “demagnification factor” such as ¼, in which example the image as formed on the substrate 23 is 4× smaller than the corresponding pattern on the reticle 10.

The projection-optical system POS is configured to form a beam crossover C.O. at an axial subdivision point, between the reticle 10 and substrate 23, that is proportional to the demagnification factor. A “contrast aperture” 18 is situated at the crossover position. The contrast aperture 18 blocks electrons that have been scattered during passage of the illumination beam through, e.g., non-patterned portions of the reticle 10. Thus, the scattered electrons (that otherwise would degrade image contrast) are prevented from reaching the substrate 23.

The substrate 23 is mounted by means of an electrostatic chuck on a substrate stage 24 that is movable along the two axes (usually termed the X- and Y-axes) perpendicular to the axis Ax (which is parallel to the Z-axis). Portions of the pattern extending outside the respective optical fields of the projection-optical system POS and illumination-optical system IOS are brought into position for exposure by appropriate movements of the substrate stage 24 in synchrony with corresponding motions of the reticle stage 11 in mutually opposite directions.

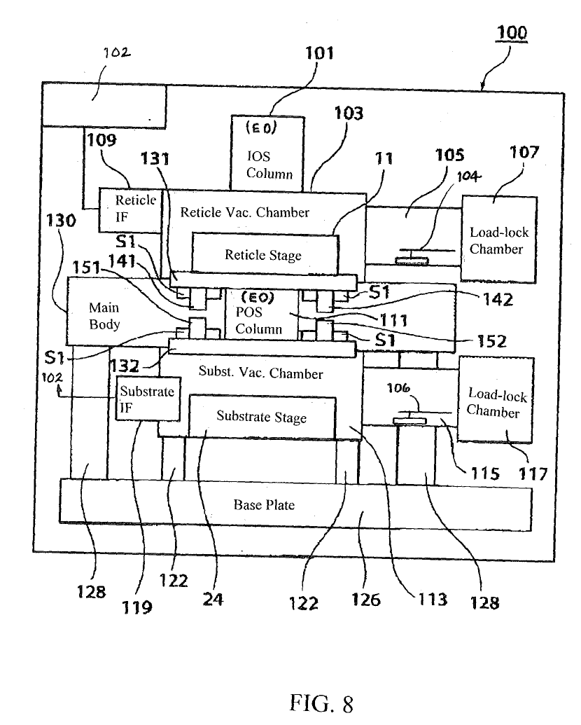

Additional details of a microlithography system 100 are shown in FIG. 8. The system 100 comprises a column 101 for the illumination-optical system, shown at the extreme upstream (top) of the figure. The electron gun 1 and illumination-optical system (IOS), collectively constituting electron optics (EO) are situated inside the IOS column 101. A reticle vacuum chamber 103, situated downstream (below in the figure) of the IOS column 101, contains the reticle stage 11.

A reticle-loader chamber 105 and reticle load-lock chamber 107, shown to the right in FIG. 8, are connected to the reticle vacuum chamber 103. Multiple reticles, each defining a respective pattern to be transferred microlithographically, are stored inside the reticle-loader chamber 105, which includes a built-in manipulator 104 or robot used for exchanging reticles. By operating the manipulator 104, the particular reticle currently on the reticle stage 11 can be exchanged with another reticle stored in the reticle-loader chamber 105. The interior of the reticle vacuum chamber 103 or of the reticle-loader chamber 105 is made contiguous with the interior of the reticle load-lock chamber 107 whenever reticles are being moved into or out of the apparatus 100. Such connections require appropriate manipulation and/or control of the vacuum levels in the reticle vacuum chamber 103 (and reticle-loader chamber) and reticle load-lock chamber 107, which is performed by respective vacuum pumps (not shown) connected to the reticle vacuum chamber 103 and reticle load-lock chamber 107. During normal exposure operation, the respective interiors of the IOS column 101 and reticle vacuum chamber 103 are evacuated to high vacuum.

A reticle interferometer (IF) 109, shown to the left in FIG. 8, also is contained inside the reticle vacuum chamber 103. The reticle interferometer 109 is connected to a controller 102. The reticle interferometer provides extremely accurate data concerning the position of the reticle stage 11 in its X-Y plane, and routes the positional data to the controller 102 for processing. On the basis of such data, the controller 102 controls the position of the reticle stage 11 precisely in real time.

The reticle stage 11 is supported by a first, or reticle, plate 131 that serves as a bulkhead and mounting plate for the reticle stage 11 and other components and instruments as desired. A second plate (bulkhead) 132 is disposed downstream of the reticle bulkhead 131. A projection-optical system (POS) column 111 is sandwiched between the first and second bulkheads 131, 132. The bulkheads 131, 132 are made from, e.g., mild steel plate or similar material. The first projection lens 15 and second projection lens 19 (collectively constituting respective electron optics EO, not detailed in FIG. 8 but described above and shown in FIG. 9) are situated inside the POS column 111 between the bulkheads 131, 132.

Within the confines of the POS column 111, a reticle auto-focus device 141 and reticle auto-alignment device 142 are mounted on the “bottom” surface of the reticle bulkhead 131. Similarly, a substrate auto-focus device 151 and substrate auto-alignment device 152 are mounted on the top surface of the substrate bulkhead 132. The two bulkheads 131, 132 are held and fixed by a main body 130.

A substrate vacuum chamber 113 is disposed downstream of the substrate bulkhead 132. The substrate stage 24, described above, is situated inside the substrate vacuum chamber 113. A substrate-loader chamber 115 and substrate load-lock chamber 117, shown to the right in FIG. 8, are connected to the substrate vacuum chamber 113. Respective vacuum pumps, not shown, are connected to the substrate vacuum chamber 113 and substrate load-lock chamber 117. During normal exposure operation, the respective interiors of the POS column 111 and substrate vacuum chamber 113 are evacuated to a high vacuum.

A substrate interferometer (IF) 119, shown to the left in FIG. 8, also is contained inside the substrate vacuum chamber 113. The substrate interferometer 119 is connected to the controller 102 in the same manner as the reticle interferometer 109. The substrate interferometer 119 provides extremely accurate data concerning the position of the substrate stage 24 in its X-Y plane, and routes the positional data to the controller 102 for processing. On the basis of such data, the controller 102 controls the position of the substrate stage 24 precisely in real time.

The substrate vacuum chamber 113 is supported on a stand 122 mounted to a system base plate 126. The main body 130 is supported on an active-vibration-isolation stand 128 mounted to the system base plate 126.

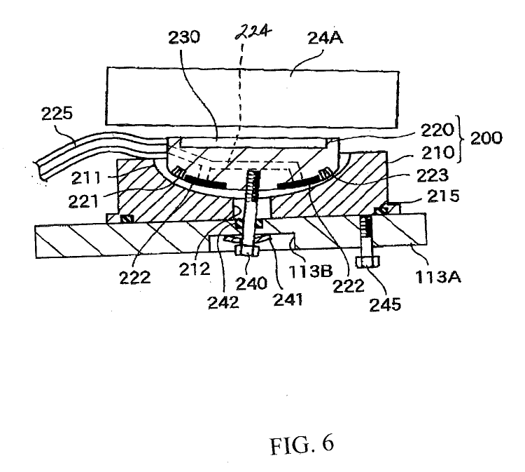

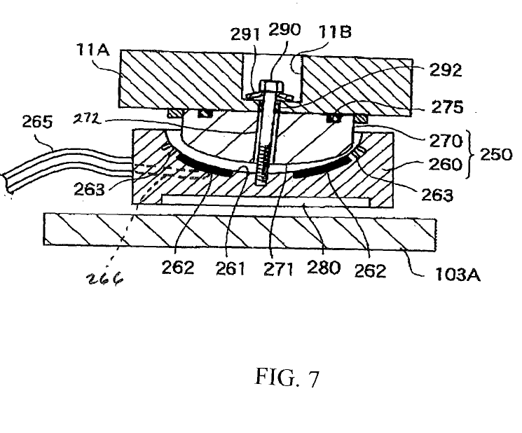

Representative embodiments of spherical static-pressure bearings used in the system described above are shown in FIGS. 6 and 7. FIG. 6 is an elevational section of a spherical static-pressure bearing used in association with the substrate stage, and FIG. 7 is an elevational section of a spherical static-pressure bearing used in association with the reticle stage. Typically, multiple respective spherical static-pressure bearings are used in association with the reticle stage and substrate stage, and used for mounting the reticle stage and substrate stage, respectively, to respective mounting members.

Referring first to the embodiment shown in FIG. 6, the spherical static-pressure bearing 200 for the substrate stage comprises a bearing seat 210 and a bearing body 220. The bearing seat 210 is mounted to the “top” surface of the “bottom” wall 113A of the substrate vacuum chamber (see FIG. 8), wherein the wall 113A is an exemplary mounting member for the substrate stage. A vacuum-sealing O-ring 215 is situated between the bearing seat 210 and the chamber wall 113A. The “upper” surface of the bearing seat 210 defines a concave spherical bearing surface 211. A conforming convex bearing surface 221 is defined on the bearing body 220 and situated opposite the concave bearing surface 211 in the bearing seat 210. The bearing surface 211 desirably has a slightly larger radius than the radius of the bearing surface 221 to prevent their unexpected contact with each other. This difference in radii is shown greatly exaggerated in the figure. A bearing pad 222, made of a gas-porous material, is provided in the convex bearing surface 221 of the bearing body 220. The bearing pad 222 has an annular shape when viewed from above.

A gas-supply hose 225 is connected to the bearing body 220, which defines appropriate conduits 224 from the gas-supply hose 225 to the bearing pad 222. Gas (e.g, air) supplied from a source by the gas-supply hose 225 passes through the bearing pad 222 and provides a gas fluid bearing between the bearing body 220 and the bearing seat 210. Thus, the bearing body 220 “floats” on a cushion of gas (e.g, air), between the concave bearing surface 211 and the convex bearing surface 221, relative to the bearing seat 210 without contacting the bearing seat 210. In this embodiment, at least one “exhaust groove” 223 is defined in the convex bearing surface 221 of the bearing body 210, outboard of the bearing pad 222. The exhaust groove 223 scavenges air (or other gas) discharged from the bearing pad 222, thereby preventing large amounts of the bearing gas from leaking into the vacuum chamber 113.

The base 24A of the substrate stage (see FIG. 8) is mounted, by means of a planar static-pressure bearing 230, on “top” of the bearing body 220. The planar static-pressure bearing 230 comprises a portion of a reaction-force-control mechanism, which is operable to absorb and control reaction forces in the substrate stage using a counter-mass system and/or active damping. By way of example, the reaction-force-control mechanism can be configured in the manner disclosed in Japan Kôkai Patent Document No. 2000-234811.

A bolt (or analogous “bearing-locking” mechanism) 240 extends through the bearing seat 210 into the bearing body 220. The bolt 240 is spring-loaded in the “vertical” direction (i.e., along the longitudinal axis of the bolt) by means of a spring washer 241 or analogous device situated in a recess 113B in the chamber wall 113A. The head of the bolt 240 contacts the spring washer 241 while the threaded shaft of the bolt extends through the chamber wall 113A. The shaft passes through the bearing seat 210 via a through-hole 212, and the distal end of the bolt 240 is threaded into the bearing body 220. The through-hole 212 has a diameter that is larger than the diameter of the bolt 240, which allows the bolt 240 to tilt relative to the bearing seat 210. Due to deformations of the bearing body 220 and bearing seat 210 (such deformations being shown greatly exaggerated) accompanying movement of the bearing body 220 relative to the bearing seat 210, the bearing surfaces are displaced. Also, the bolt 240 experiences a slight tilt (again, greatly exaggerated in the figure) relative to the bearing body 220. An O-ring 242 provides a seal from the wall 113A to the shaft of the bolt 240. The tilt angle of the bolt 240 normally is no greater than several hundred mrad. The O-ring 242 is capable of maintaining an effective seal under such conditions.

A jack bolt 245 or analogous lifting or height-adjustment mechanism is threaded through or otherwise extended through the chamber wall 113A “beneath” the bearing seat 210 so as to contact the “under”-surface of the bearing seat 210. By turning the jack bolt 245 and inserting a shim as required (described later below) between the wall 113A and bearing seat 210, the “height” of the corresponding region of the bearing seat 210 relative to the chamber wall 113A can be adjusted. An advantage of the jack bolt 245 is its simple operation and its accessibility (and operability) from outside the vacuum chamber 113.

Turning now to FIG. 7, an embodiment of a spherical static-pressure bearing 250 for the reticle stage 11 is shown. The bearing 250 comprises a bearing seat 260 and a bearing body 270, both configured with respective spherical bearing surfaces similarly to respective components in FIG. 6. (Again, the radii of the spherical bearing surfaces are shown greatly exaggerated relative to each other.) The bearing body 270 is fastened to the “bottom” surface of the base 11A of the reticle stage (see FIG. 8). A vacuum-sealing O-ring 275 is situated between the bearing body 270 and the stage base 11A. The bearing seat 260 is mounted to the upper surface of the wall 103A of the reticle vacuum chamber (see FIG. 8) with an intervening planar, non-contacting static-pressure bearing 280. The wall 103A is an exemplary mounting member for the reticle stage.

The spherical static-pressure bearing 250 also comprises a bearing pad 262, made of a gas-porous material, mounted in the concave bearing surface 261 of the bearing seat 260. At least one exhaust groove 263 is defined in the concave bearing surface 261, outboard of the bearing pad 262. In this embodiment no bearing pad or exhaust groove is provided in the convex bearing surface 271 of the bearing body 270. A gas-supply hose 265 is connected to the bearing seat 260, which defines an internal conduit 266 that routes bearing gas from a source through the hose 265 to the bearing pad 262.

A bolt 290 or analogous device is provided as an exemplary bearing-locking mechanism. The bolt 290 is spring-loaded in the “vertical” direction (i.e., along the longitudinal axis of the bolt) by means of a spring washer 291 situated (along with the head of the bolt 290) in a recess 11B defined in the stage base 11A. The bolt 290 extends through a through-hole in the stage base 11A and a corresponding through-hole 272 in the bearing body 270. A space between the shaft of the bolt 290 and the stage base 11A is vacuum-sealed using an O-ring 292. The distal end of the bolt 290 is threaded into the bearing seat 260. Thus, the shaft of the bolt 290 can be tilted inside the through-hole 272 relative to the bearing body 270.

Alternatively to using a bolt as a bearing-locking mechanism, bearing locking can be achieved by, for example, employing permanent magnets and electromagnets. For example, a permanent magnet can be embedded into the bearing surface of the bearing body and an opposing electromagnet can be embedded into the bearing surface of the mating bearing seat (or vice versa). Energization of the electromagnetic relative to the permanent magnet arrests motion of the bearing body relative to the bearing seat.

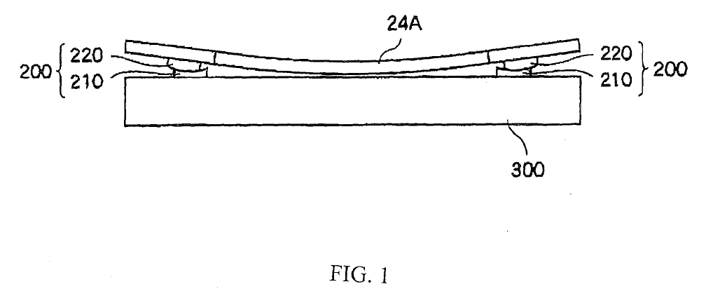

Steps of a representative embodiment of a process for mounting a substrate stage in a microlithography system are described with reference to FIGS. 1-5, which depict the results of respective steps in the process. In a first step, as shown in FIG. 1, the bearing seats 210 of the spherical static-pressure bearings 200 described above (see FIG. 6) are mounted to the “upper” surface of a rigid base 300, which is mounted relative to a floor or the like. Respective bearing bodies 220 are placed in the bearing seats 210, and a stage base 24A of a substrate stage is mounted to the bearing bodies 220. In this manner a respective spherical static-pressure bearing 200 is situated at each of the four corners of the stage base 24A. The rigid base 300 is adequately leveled. After assembly, air (or other gas) is supplied to the spherical static-pressure bearings 200. If the stage base 24A flexes and/or sags under its own weight (shown greatly exaggerated in FIG. 1), the spherical static-pressure bearings 200 experience corresponding rotation of their respective bearing bodies 220 relative to their respective bearing seats 210 (again, shown greatly exaggerated).

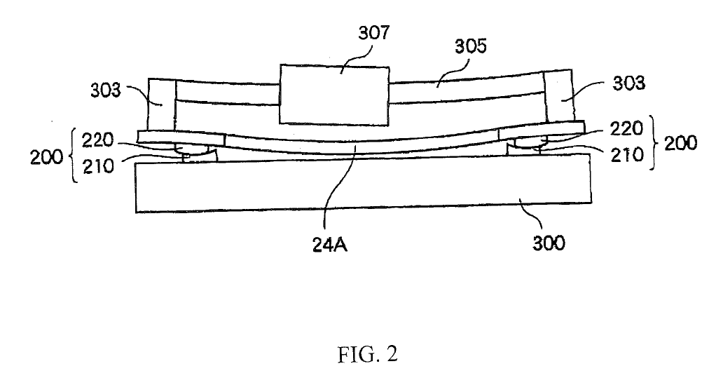

In a second step (FIG. 2) guide-bar supports 303 and linear-motor supports (not shown) are mounted on the “upper” surface of the stage base 24A. Guide bars 305, an X-Y table (i.e., a slider, with internal actuator) 307, and a linear motor (not shown) are mounted to the respective supports. Meanwhile, air (or other suitable gas) is supplied to the spherical static-pressure bearings 200, as in the first step. Note the greatly exaggerated sag of the stage base 24A and guide bar 305 relative to the rigid base 300, as well as rotation of the bearings 200.

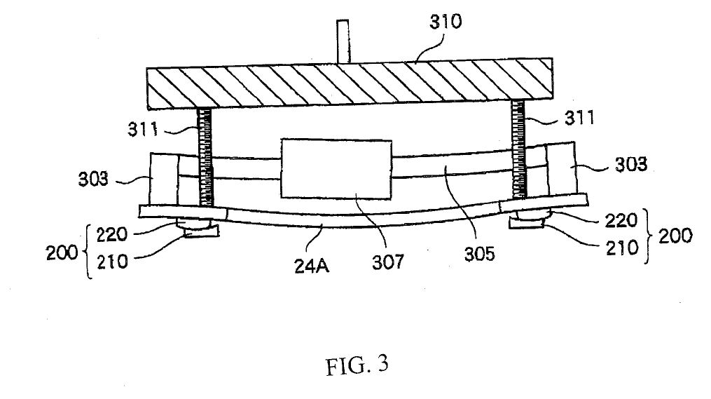

In the third step (FIG. 3) suspension bolts 311 are mounted to the stage plate 24A directly “above” the respective spherical static-pressure bearings 200. The suspension bolts 311 are affixed to a rigid “hanger” plate 310. Any required transportation of the stage base 24A (and components mounted thereto) from the rigid base 300 to a mounting member to which the stage will be installed is performed by grasping he hanger plate 310 while the stage base 24A is suspended from the hanger plate 310. Air (or other suitable gas) is not supplied to the spherical static-pressure bearings 200 at this time.

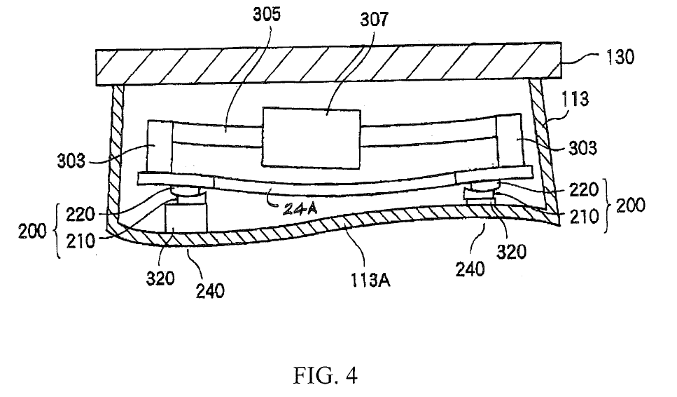

In the fourth step (FIG. 4) the substrate stage 24 is removed from the rigid base 300 and transferred (while still suspended from the hanger plate 310) to inside the substrate chamber 113. At this time, shims 320 are installed, as required at each of the four bearings, between the chamber wall 113A (the mounting member for the stage 24) and the bearing seats 210 of the spherical static-pressure bearings 200. The shims 320 offset stress-related displacement (shown greatly exaggerated) of the vacuum chamber 113 in the Z-direction and/or other direction. The thickness of each shim 320 is selected such that the stage base 24A has the same “height” at each of its four corners, thereby effectively leveling the guide bar 305. Air (or other suitable gas) is supplied to the spherical static-pressure bearings 200 during this time. Thus, deformation of the stage 24 due to tilting or distortion of the vacuum chamber 113 is reduced by the shims 320 and corresponding rotations of the respective spherical static-pressure bearings 200.

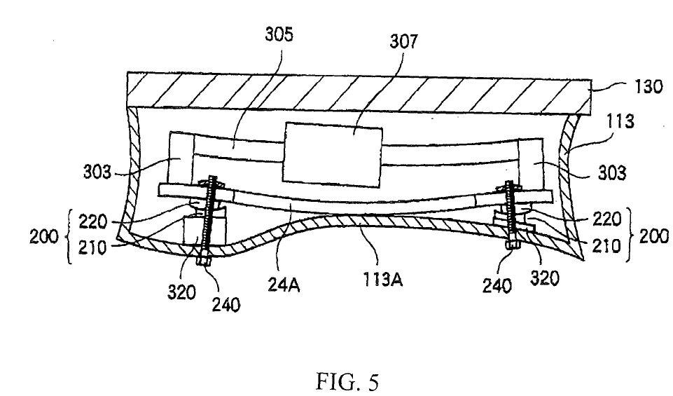

In the fifth step (FIG. 5) the interior of the vacuum chamber 113 is evacuated to a suitable high-vacuum (e.g., 10⁻⁴ Pa). The vacuum chamber 113 typically exhibits slight deformation (shown greatly exaggerated) by this evacuation, as typically does the stage base 24A. But, this deformation is ameliorated by corresponding rotations of the spherical static-pressure bearings 200. After completing vacuum evacuation, delivery of air (or other gas) to the spherical bearings is halted, and each spherical static-pressure bearing 200 is locked by tightening the respective bolt (or analogous locking mechanism). The bolts 240 thus link the stage base 24A to the chamber wall 113A via the spring washers 241, spherical static-pressure bearings 200, and shims 320.

Any drive reaction force in the substrate stage 24 is absorbed by the reaction-force-control mechanism, which includes the planar static-pressure bearings 230, discussed above with reference to FIG. 6.

A similar assembly process to that shown in FIGS. 1-5 desirably is followed when assembling the reticle stage 11.

As is clear from the foregoing description, a stage apparatus (e.g., reticle and/or substrate stage) is provided for a microlithography system. The stage apparatus is configured and is assembled into the microlithography system in a manner by which stage deformation arising during assembly and deformation accompanying vacuum evacuation of the chamber in which the stage apparatus is located are controllably reduced.

Whereas the invention has been described in connection with representative embodiments, it will be understood that the invention is not limited to those embodiments. On the contrary, the invention is intended to encompass all modifications, alternatives, and equivalents as may be included within the spirit and scope of the invention, as defined by the appended claims.

What is claimed is:

1. A stage apparatus for moving an object relative to a mounting member, the stage apparatus comprising:
a stage base;
a stage table;
an actuator coupled between the stage base and stage table, the actuator being configured for moving and positioning the stage table relative to the stage base;
a guide mechanism mounted to the stage base and configured to guide movements of the stage table imparted by the actuator; and
multiple spherical static-pressure bearings situated between the stage base and the mounting member.

2. The stage apparatus of claim 1, wherein:
the stage base is a plate having multiple corners; and
a respective spherical static-pressure bearing is situated between each corner and the mounting member.

3. The stage apparatus of claim 1, wherein:
the stage is a reticle stage or substrate stage for use in a microlithography system; and
the object is a reticle or substrate, respectively.

4. The stage apparatus of claim 1, wherein each spherical static-pressure bearing comprises a respective bearing-locking mechanism.

5. The stage apparatus of claim 4, wherein:
each spherical static-pressure bearing comprises a bearing seat and a bearing body coupled together so as to define a spherical fluid bearing therebetween; and
the bearing-locking mechanism further comprises a lock screw extending between the bearing seat and the bearing body.

6. The stage apparatus of claim 5, wherein the lock screw is spring-loaded in an axial direction of the lock screw.

7. The stage apparatus of claim 1, wherein:
each spherical static-pressure bearing comprises a respective bearing seat and bearing body coupled together so as to define a respective spherical fluid bearing therebetween; and
the fluid bearing comprises a respective bearing pad through which a gas is discharged into the fluid bearing.

8. The stage apparatus of claim 7, wherein each fluid bearing comprises:
a concave bearing surface defined in the bearing seat and a mating convex bearing surface defined in the bearing body; and
at least one exhaust groove defined in at least one of the bearing surfaces, the exhaust groove being configured to scavenge gas discharged from the respective bearing pad.

9. The stage apparatus of claim 1, further comprising at least one height-adjustment mechanism situated either between the stage base and a respective spherical static-pressure bearing or between the respective spherical static-pressure bearing and the mounting member.

10. The stage apparatus of claim 9, wherein:
the stage apparatus is configured for use inside a sealable chamber; and
the height-adjustment mechanism is operable from outside the chamber.

11. The stage apparatus of claim 10, wherein the height-adjustment mechanism comprises a jack bolt.

12. The stage apparatus of claim 9, wherein the height-adjustment mechanism further comprises a respective shim situated either between the stage base and a respective spherical static-pressure bearing or between the respective spherical static-pressure bearing and the mounting member.

13. The stage apparatus of claim 1, further comprising at least one planar static-pressure bearing situated either between the spherical static-pressure bearings and the mounting member, between the spherical static-pressure bearings and the stage base, or between the stage base and the stage table.

14. A microlithography system for transferring a pattern to a sensitized substrate using an energy beam, the system comprising:
an optical system situated and configured to direct the energy beam to the substrate;
a mounting member; and
a stage apparatus for moving the substrate or a reticle relative to the optical system, the stage apparatus comprising (a) a stage base, (b) a stage table, (c) an actuator, coupled between the stage base and stage table, configured for moving and positioning the stage table relative to the stage base, (d) a guide mechanism mounted to the stage base and configured to guide movements of the stage table imparted by the actuator, and (e) multiple spherical static-pressure bearings situated between the stage base and the mounting member.

15. The system of claim 14, wherein the energy beam is a charged particle beam or EUV beam.

16. The system of claim 14, further comprising a vacuum chamber housing at least the stage apparatus.

17. The system of claim 14, wherein:
the stage base is a plate having multiple corners; and
a respective spherical static-pressure bearing is situated between each corner and the mounting member.

18. The system of claim 14, wherein the stage is a reticle stage or substrate stage.

19. The system of claim 14, wherein each spherical static-pressure bearing comprises a respective bearing-locking mechanism.

20. The system of claim 19, wherein:
each spherical static-pressure bearing comprises a respective bearing seat and bearing body coupled together so as to define a respective spherical fluid bearing therebetween; and
the bearing-locking mechanism further comprises a lock screw extending between the bearing seat and the bearing body.

21. The system of claim 20, wherein the lock screw is spring-loaded in an axial direction of the lock screw.

22. The system of claim 14, wherein:
each spherical static-pressure bearing comprises a respective bearing seat and bearing body coupled together so as to define a respective spherical fluid bearing therebetween; and
the fluid bearing comprises a respective bearing pad through which a gas is discharged into the fluid bearing.

23. The system of claim 22, wherein each fluid bearing comprises:
a concave bearing surface defined in the bearing seat and a mating convex bearing surface defined in the bearing body; and
at least one exhaust groove defined in at least one of the bearing surfaces, the exhaust groove being configured to scavenge gas discharged from the respective bearing pad.

24. The system of claim 14, further comprising at least one height-adjustment mechanism situated either between the stage base and a respective spherical static-pressure bearing or between the respective spherical static-pressure bearing and the mounting member.

25. The system of claim 24, wherein:
the stage apparatus is configured for use inside a sealable chamber;
the mounting member is a wall of the chamber; and
the height-adjustment mechanism is operable from outside the chamber.

26. The system of claim 25, wherein the height-adjustment mechanism comprises a jack bolt.

27. The system of claim 24, wherein the height-adjustment mechanism further comprises a respective shim situated either between the stage base and a respective spherical static-pressure bearing or between the respective spherical static-pressure bearing and the mounting member.

28. The system of claim 14, further comprising at least one planar static-pressure bearing situated either between the spherical static-pressure bearings and the mounting member, between the spherical static-pressure bearings and the stage base, or between the stage base and the stage table.

29. A method for mounting, to a mounting member, a stage apparatus including a stage base and a stage table, the method comprising the steps:
placing multiple spherical static-pressure bearings at respective locations between the stage base and a rigid base;
while discharging a gaseous bearing fluid into the spherical static-pressure bearings, allowing the bearings to rotate in response to deformation being exhibited by the stage base;
assembling the stage apparatus, including the stage table, on the stage base;
while discharging the bearing fluid into the spherical static-pressure bearings, allowing the bearings to rotate in response to deformation being exhibited by the stage resulting from assembling the stage;
while suspending the stage from a hanger plate, transporting the stage to the mounting member and mounting the stage by the spherical static-pressure bearings to the mounting member;
while discharging the bearing fluid into the spherical static-pressure bearings, allowing the bearings to rotate in response to deformation of the mounting member, and adjusting respective distances as required between individual spherical bearings and the mounting member or between individual bearings and the stage base as required to offset deformation of the mounting member; and
locking the spherical bearings.

30. The method of claim 29, wherein:
the mounting member is a wall of a vacuum chamber in which the stage apparatus is mounted; and
the method further comprises the steps, before locking the spherical bearings, of evacuating the chamber and, while discharging the bearing fluid into the spherical static-pressure bearings, allowing the bearings to rotate in response to deformation of the wall arising in response to the evacuation of the chamber.

31. The method of claim 29, wherein the step of locking the spherical bearings comprises tightening a respective lock screw associated with each spherical bearing.

32. The method of claim 29, wherein the stage apparatus is a reticle stage or substrate stage used in a microlithography system.

33. The method of claim 29, further comprising the step of providing at least one planar static-pressure bearing situated either between the spherical static-pressure bearings and the mounting member, between the spherical static-pressure bearings and the stage base, or between the stage base and the stage table.

34. The method of claim 29, wherein the step of adjusting respective distances comprises turning respective jack screws situated between individual spherical bearings and the mounting member or between individual bearings and the stage base.

35. The method of claim 34, wherein the step of adjusting respective distances further comprises inserting respective shims between the individual spherical bearings and the mounting member or between individual spherical bearings and the stage base.

36. The method of claim 29, wherein the step of adjusting respective distances comprises inserting respective shims between the individual spherical bearings and the mounting member or between individual spherical bearings and the stage base.
